(19) United States
(12) Patent Application Publication
(10) Pub. No.: US 2025/0216315 A1
(43) Pub. Date: Jul. 3, 2025

(54) CELL COUNTING DEVICE

(71) Applicant: BEYOND BLOOD DIAGNOSTICS LTD., London (GB)

(72) Inventor: Manfredi Giovanni SAN MARTINO D'AGLIE DI SAN GERMANO, London (GB)

(21) Appl. No.: 18/833,680

(22) PCT Filed: Jan. 26, 2023
(86) PCT No.: PCT/GB2023/050163

§ 371 Date: Jul. 26, 2024

(30) Foreign Application Priority Data
Jan. 26, 2022 (GB) 2201016.9

(51) Int. Cl. G01N 15/1434; B01L 3/00; G01N 15/14

(52) U.S. Cl. CPC G01N 15/1434; B01L 3/502715; G01N 15/1459; G01N 15/1484; B01L 2300/0654; B01L 2300/0877; G01N 2015/1486

(57) ABSTRACT

The described invention is a cell counting device for counting target cells within a fluid, the device comprising: a microfluidic channel configured to receive a flow of a cell-containing fluid through an inlet and conduct the flow of the cell-containing fluid along the channel, the microfluidic channel sized such that target cells within the cell-containing fluid flow consecutively through the microfluidic channel; a first photodetector arranged to receive light that has passed through the microfluidic channel at a first measurement point, such that signal from the photodetector varies due to the received light being restricted by the passage of cells across the first measurement point in the microfluidic channel; a processing unit configured to receive a signal from the photodetector and distinguish the size of a cell passing the first measurement point based on an interruption time during which the signal intensity received from the photodetector is reduced, thereby determining the presence of a target cell type. Using an optical interruption signal in this way, provides a low cost device that does not require fluorescent dyes to label the cells nor does it require lasers, microscopes or other specialist equipment such that the device is suitable for point-of-care and at-home use and does not require the direction of a trained specialist operator.

### FIELD OF THE INVENTION

The invention relates to a cell counting device for counting cells within a fluid, in particular a microfluidic device for identifying one or more target cell types as they flow within a cell-containing fluid past a measurement point.

### BACKGROUND

Cell enumeration and identification are essential processes in modern medical research and diagnosis. Accordingly, methods for the analysis of bodily fluids using various technologies have become a growing area of interest to the scientific community. Existing automated cell counting devices can be categorised into three main groups based on their method of detection: optical analysis, image analysis, and electrical impedance. Such devices have many applications including haematological analysis, semen analysis, and urine analysis.

In particular, a complete blood count (CBC) test—a type of haematological analysis—provides an estimated cell count for each blood cell type in a given sample. CBC tests are one of the most commonly used diagnostic tools in hospitals today. One important use of this test is to monitor the blood count of patients undergoing chemotherapy. Chemotherapy aims to destroy cancer cells, but, in the process, it affects the growth and replication of normal cells, such as blood cells produced in the bone marrow. Abnormal counts of red blood cells, white blood cells, or platelets can lead to various health complications and need to be identified early on. Such information is vital for a medical professional to know in order to develop an informed treatment plan based on the patients' current health status.

Additionally, CBC tests can give a white blood cell differential count, which is a measure of the number of each type of white blood cell present in a sample. This information is especially important today with the observed rise in antibiotic resistant bacteria caused by the overprescription of antibiotics by doctors. Consequently, when a patient develops a bacterial infection, it needs to be identified quickly. Ideally, an in-situ device capable of retrieving these measurements would be implanted into the patient for real-time data collection. Such a device could be applied to many other medical uses including the monitoring of a patient participating in a clinical trial to evaluate the effectiveness of a given drug or to identify adverse effects from the drug that would require immediate medical attention. The device may also be used to measure the white blood cell count in spinal fluid to provide important information to spinal surgeons.

Currently, hospitals use sophisticated machinery to employ methods of optical analysis, electrical impedance, or centrifugal separation to carry out the blood tests discussed above. Tests of this kind are carried out using large and complex equipment, often with hazardous moving parts, restricted to use in hospitals or laboratories. There is, therefore, a need for a portable device to replace this bulky and expensive equipment.

One optical detection method proposed to solve the above-mentioned problem is a flow cytometry system based on a microfluidic chip. Flow cytometry employs lasers as a light source to produce scattered and fluorescence signals from a cell in a fluid as it pass through the light path emitted by the lasers. These signals can be detected by devices such as photosensors or photomultiplier tubes. Basing this system on a microchip requires the miniaturisation of all the components. However, due to the many complex components necessary to the functionality of the device, it is limited in both size and cost. Further, the use of lasers causes alignment problems, in addition to the cells often requiring labelling with a fluorescence marker, making this device inaccessible to an untrained user. Due to these problems, this device is not portable in practice, deeming it redundant for use as an at-home or implantation device.

Another important application of cell counting is to aid in acquiring a blood count for athletes or race horses immediately before an event in an effort to eliminate the presence of performance-enhancing drugs. Performance-enhancing drugs can increase the red blood cell count such that a cell counting device could identify if a participant has been taking these drugs. Athletes and race horses are regularly drug tested throughout their careers, however, countless stories are reported of athletes still managing to participate in events with dopants in their system. A cell counting device able to provide rapid, accurate information on the blood count of athletes immediately before an event could prove invaluable to overcoming the presence of performance-enhancing drugs in modern sporting events.

Another important application of cell counting is to gather information regarding the sperm count in a sample. This is particularly important within the agricultural industry, where, for example, dairy farmers prefer to produce female cows over male cows for their milk production. Knowing the ratios of sperm carrying male genetic material to those carrying female genetic material could increase the chances of the dairy farmer producing female cows through IVF, thereby maximising their yield. This example could be applied throughout the agricultural industry. This application of cell counting requires minimal interference with the cells as to not damage them or to deem the sample redundant for use. In addition, cell counting may be used for veterinarian purposes to count a particular target animal cell type in a sample. For example, a complete blood count provides valuable information on an animal's health. A device able to obtain this information without placing unnecessary stress on the animal is desirable. Such a device could also be used to analyse other fluids of the animal.

Due to the above-mentioned problems, there exists a need for a device that is cost-effective, simple in design, and appropriate for point-of-care and at-home fluid analysis without the need for operation by a trained professional. There is also a need for a device able to return accurate and rapid results. Furthermore, a device is needed that minimises the interference to living cells such that it is suitable for both in-vivo and in-vitro tests.

### SUMMARY OF INVENTION

It is an object of the present invention to provide a cell counting device which makes progress in solving some of the problems identified above.

In a first aspect of the invention there is provided a cell counting device for counting target cells within a fluid, the device comprising: a microfluidic channel configured to receive a flow of a cell-containing fluid through an inlet and conduct the flow of the cell-containing fluid along the channel, the microfluidic channel sized such that target cells within the cell-containing fluid flow consecutively through the microfluidic channel; a first photodetector arranged to receive light that has passed through the microfluidic channel at a first measurement point, such that signal from the photodetector varies due to the received light being restricted by the passage of cells across the first measurement point in the microfluidic channel; a processing unit configured to receive a signal from the photodetector and distinguish the size of a cell passing the first measurement point based on an interruption time during which the signal intensity received from the photodetector is reduced, thereby determining the presence of a target cell type.

The term “light being restricted” is used to refer to the light that is partially or wholly absorbed by the passage of cells based on the absorption properties and/or reflective properties of the cell type such that the light reaching the photodetector is restricted. Using an optical interruption signal in this way, provides a low cost device that does not require fluorescent dyes to label the cells nor does it require lasers, microscopes or other specialist equipment such that the device is suitable for point-of-care and at-home use and does not require the direction of a trained specialist operator. The lack of moving parts and simplistic design further makes this device suitable for the above-mentioned uses. Additionally, the present invention can count constituent cells within a sample, without requiring the sample to be diluted such that it is also suitable for use in an implantation device. The present invention can provide a means of counting every single cell in the sample as opposed to just giving an estimate of the number of cells in the sample.

Preferably, the processing unit of the cell counting device is configured to determine the presence of a target cell type based on both: the interruption time due to the passage of a cell across the first measurement point and the intensity variation of the signal during the interruption time.

Consequently, by determining the cell type independently from two measures taken of the target cell, the device reliability is further increased. In particular, the absorption spectrum differs between cells of different types, meaning that changes in intensity of the signal at the photodetector can be used as a further signal to distinguish cell types. In some cases, the absorption of light can differ across the cell so the changes in intensity as the cell passes across the measurement point can be used to further discriminate between cells The cell type is more likely to be identified correctly based on two measurements instead of only one. Additionally, in the case of two different cell types having similar interruption times, the cell counting device is advantageously able to distinguish each cell type from one another based on the intensity variation of the signal during the interruption time and vice versa.

Preferably, the minimum width dimension of the microfluidic channel is less than the diameter of a target cell type within the fluid when in a relaxed state, such that the target cell type is deformed from its relaxed shape as it flows through the microfluidic channel.

The term “minimum width dimension” is used to refer to the smallest distance between the walls of the microfluidic channel. In particular, the width dimension may be measured in a direction across the channel, perpendicular to the flow direction. The term “relaxed state” is used to refer to a cell in its natural state with no external forces causing it to deform or change in shape from its natural dimensions. In this embodiment, the target cell type will deform as it flows through the microfluidic channel based on its mechanical and elastic properties. When deformed, the target cell is in contact with the walls of the microfluidic channel such that frictional forces acting on the target cell cause it to slow down. A different cell type will deform by a different degree to the target cell type due to its different mechanical and elastic properties. The deformation and slowing down of the cells in the microfluidic channel results in a longer interruption time such that the cell types may be more readily distinguished due to a larger difference in the interruption time measurement between the target cell and the different cell types.

In some embodiments, the cell counting device further comprises a second photodetector arranged to receive light that has passed through the microfluidic channel at a second measurement point, such that signal from the photodetector varies due to the received light being restricted by the passage of cells across the second measurement point in the microfluidic channel; wherein the first measurement point and second measurement point are separated along the microfluidic channel in the flow direction; wherein the processing unit is configured to: receive signals from the first and second photodetectors and determine a speed at which a cell traverses a distance separating the first and second measurement points within the microfluidic channel; and determine the presence of a target cell type using the determined speed.

As mentioned above, cells deform and slow down by a different degree based on their properties. Cell types of a similar size will transverse the microfluidic channel at slightly different speeds when deformed such that by determining the speed at which the target cell transverses the microfluidic channel, different cell types of a similar size can be differentiated based on small differences in their speed measurement. Additionally, different cell types that move actively with different speeds can be differentiated based on the speed at which they transverse the microfluidic channel.

Preferably, the minimum width dimension of the microfluidic channel is less than the diameter of a target cell type within the fluid when in a relaxed state, such that the target cell type is deformed from its relaxed shape as it flows through the microfluidic channel; wherein the processing unit is configured to: determine the size of the cell using the determined speed at which the cell is travelling and the interruption time of the signal received from the first and/or second photodetector.

Advantageously, a second photodetector providing a second interruption time measurement can be used to confirm that the cell type identified at the first photodetector is correct. Additionally or alternatively, by comparison of the first interruption time with the second interruption time, anomalies in these measurements can be identified, for example, measurements affected by blockages or slowing of prior cells in the microfluidic channel can be identified. In this way, the anomalies can be flagged up or altered such that they are determined to be the correct cell type. These measurements used in addition to a speed measurement for a target cell type increase the likelihood of determining the cell type correctly and identifying anomalies in the cell count.

In some embodiments, the cell counting device comprises an autofluorescence sensor comprising an excitation light source and an autofluorescence photodetector arranged to receive autofluorescence emissions from a cell illuminated by the excitation light source; wherein the processing unit is configured to receive signal from the autofluorescence photodetector and determine a the presence of a target cell type based on the intensity of the received signal.

The term “excitation light source” is used to refer to a light source configured to emit light at a specific wavelength or at a bandwidth containing a specific wavelength which known by the skilled person to excite the target cell type. “Autofluorescence” refers to the natural emission of fluorescence from the target cell produced when the target cell is excited by the excitation light source. Advantageously, the autofluorescence sensor alone can differentiate different cell types they fluoresce at different intensities for a given wavelength. Particularly, in the case where two or more cell types may be the same size such that they cannot be identified from the interruption time or the speed measurements alone, the cell types may emit a different intensity signal at a given wavelength such that the processing unit is able to distinguish between them based on the received intensity signal. Therefore, in a sample of cell types known to fluoresce at different intensities, a simplistic cell counting device comprising an autofluorescence sensor can be employed.

In such an embodiment, preferably the excitation light source is configured to provide light of wavelength in the range 250-700 nm. Advantageously, many cell types are known to be excited by wavelength(s) in this range.

The cell counting device may comprise a first excitation light source configured to emit light of wavelength in the range 300-400 nm, more preferably 360-370 nm; and a second excitation light source configured to emit light of wavelength in range 400-500 nm, preferably 430-440 nm. In particular, white blood cell types are known to the skilled person to be excited by wavelengths in these ranges and provide fluorescence emissions that different in relative intensity between cell types, allowing different cell types to be distinguished and counted.

Preferably, the autofluorescence photodetector is positioned on an opposite side of the microfluidic channel to the excitation light source, the cell counting device further comprising: an excitation light filter arranged between the microfluidic channel and the autofluorescence photodetector, the excitation light filter configured to block light in the wavelength range emitted by the excitation light source.

Arranged in this way, the excitation filter prevents excitation light from reaching the autofluorescence photodetector thereby reducing noise in the signal.

Preferably, the autofluorescence photodetector comprises the first photodetector, wherein the processing unit is configured to receive signal from the first photodetector, wherein the signal comprises both: a varying intensity signal due to the received light being restricted by the passage of cells across the first measurement point in the microfluidic channel; and an autofluorescence signal due to the autofluorescence emissions received from a cell passing the first measurement point in the microfluidic channel.

Advantageously, two independent signal measurements improves the reliability of the device is by increasing the likelihood of correctly identifying the cell type. In particular, autofluorescence is a characteristic of the cell type, much like the size, such that both measurements should be consistent over all cells of one type.

In some embodiments, the microfluidic channel has a minimum width dimension of 1 μm-20 μm, preferably 5-15 μm, more preferably 8-12 μm. These channel widths are suitable to ensure that blood cells must pass through the channel one after another (and not side-by-side) whilst also ensuring that certain blood cell types must deform since these dimensions are smaller than the largest dimension of a blood cell. The deformation causes the blood cells to pass more slowly through the channel, providing a stronger signal for discrimination and counting.

In some examples the flow rate of the fluid is used by the processor in determining a target cell type. In particular, the processor may be able to determine a cell type based on the degree to which a cell has been slowed by the restriction of the channel relative to the nominal fluid flow rate.

In some embodiments, the target cells comprise blood cells and the microfluidic channel is sized such that the blood cells must pass consecutively through the microfluidic channel.

In some embodiments, the cell counting device comprises a second photodetector arranged to receive light that has passed through the microfluidic channel at a second measurement point, such that signal from the photodetector varies due to the received light being restricted by the passage of cells across the second measurement point in the microfluidic channel, wherein the first measurement point and second measurement point are separated along the microfluidic channel in the flow direction; and an autofluorescence sensor comprising an excitation light source configured to illuminate a cell as it passes an autofluorescence measurement point and an autofluorescence photodetector arranged to receive autofluorescence emissions from the illuminated cell; wherein the processing unit is configured to receive signals from the first photodetector, the second photodetector and the autofluorescence sensor and determine the presence of a target cell type within the microfluidic channel based on one or more of: the interruption time of the signal received from the first and/or second photodetector; the speed at which a cell traverses the microfluidic channel between the first and second measurement points determined from the signals received from the first and second photodetector; and the intensity of the signal received by the autofluorescence sensor.

In this way, the embodiment of the cell counting device described above can acquire many combinations of measurements such that it is adaptable for many uses. The more information on the passing cell that is provided to the processing unit, the more likely it will correctly identify the cell type with high levels of certainty. Such a device is particularly applicable to medical uses whereby the cell counting device is required to be accurate or the patient could receive an incorrect treatment.

Preferably, the excitation light source is configured to provide excitation light comprising light in a first wavelength range for stimulating autofluorescence emission in a target cell type, the cell counting device further comprising: an illumination light source configured to provide illumination light comprising light in a second wavelength range, wherein the illumination light source is configured to illuminate the microfluidic channel at the first and second measurement points to provide the signal to the first and second photodetectors; wherein the first photodetector, second photodetector and the autofluorescence photodetector are arranged on an opposite side of the microfluidic channel to the excitation light source and the illumination light source

Advantageously, using an excitation light source emitting light with a different wavelength to the illumination light source may result in less noise in the received signal.

Preferably, the excitation light source is an ultraviolet light source and the illumination light source is an infra-red light source.

Preferably, the cell counting device further comprises an excitation and autofluorescence filter positioned between the microfluidic channel and the photodetectors, the excitation and autofluorescence filter configured to block excitation and autofluorescence light but transmit illumination light, the excitation and autofluorescence filter comprising an opening aligned so as to permit autofluorescence light from a cell at the autofluorescence measurement point to reach the autofluorescence detector; an excitation and illumination light filter positioned between the excitation and autofluorescence light filter and the photodetectors, the excitation and illumination light filter configured to block excitation and illumination light but transmit autofluorescence light, the excitation and illumination light filter comprising two openings positioned so as to permit illumination light passing through the first and second measurement positions to reach the first and second photodetectors.

Alternatively, the cell counting device comprises an excitation light filter positioned between the microfluidic channel and the photodetectors, the excitation light filter configured to block excitation light but transmit illumination light and autofluorescence light; an autofluorescence light filter positioned between the excitation light filter and the photodetectors, the autofluorescence light filter configured to block autofluorescence light but transmit illumination light, the autofluorescence light filter comprising an opening aligned so as to permit autofluorescence light from a cell at the autofluorescence measurement point to reach the autofluorescence detector; an illumination light filter positioned between the autofluorescence filter and the photodetectors, the illumination light filter configured to block illumination light and transmit autofluorescence light, the illumination light filter comprising two openings arranged to permit illumination light passing through the first and second measurement points to reach the first and second photodetectors.

Preferably, the cell counting device comprises a focal lens positioned between the excitation light source and the microfluidic channel, the focal lens configured to focus the excitation light towards the third measurement point in a direction perpendicular to the microfluidic channel.

Preferably, the cell counting device further comprising a focal lens filter positioned between the focal lens and the microfluidic channel, the focal lens filter configured to block excitation light the focal lens filter comprising an opening aligned to permit only focussed light perpendicular to the microfluidic channel to reach the third measurement point.

Advantageously, the use of filters to block out specific wavelengths of light and/or a focal lens to focus the light perpendicular to the microfluidic channel results in less noise in the received signal thereby reducing errors in interruption time measurements, speed measurements and the intensity signal such that the cell type can be correctly identified.

In a preferred embodiment, the cell counting device comprises a multipixel photodetector array wherein each of the first photodetector, the second photodetector and the autofluorescence photodetector are provided by a separate group of one or more pixels of the multipixel array.

In this way, each photodetector has its own output signal channel. This means that the signal from each photodetector is distinguished from one another at the processing unit such that the processing unit is able to identify which measurement point the signal originated from.

In some embodiments, the autofluorescence photodetector comprises the first photodetector; wherein the processing unit is configured to receive signal from the first photodetector, wherein the signal comprises both: a varying intensity signal due to the received light being restricted by the passage of cells across the first measurement point in the microfluidic channel; and an autofluorescence signal due to the autofluorescence emissions received from a cell passing the first measurement point in the microfluidic channel.

In some embodiments, the previously defined autofluorescence sensor is referred to as a first autofluorescence sensor, and the cell counting device further comprises: a second autofluorescence sensor comprising a second excitation light source configured to illuminate a cell as it passes a second autofluorescence measurement point and a second autofluorescence photodetector arranged to receive autofluorescence emissions from the excited cell; wherein the second autofluorescence photodetector comprises the second photodetector; wherein the excitation light sources of the first and second autofluorescence sensors are configured to emit light of different wavelengths.

In this way, when the target cell can be excited at multiple different wavelengths, the intensity signal at both these wavelengths can be obtained when the target cell passes through the microfluidic channel. Advantageously, when two different cells produce a similar intensity signal at a first wavelength, they may produce a different intensity signal from one another at a second wavelength such that the cell counting device can distinguish the cell type from the intensity signal at the second wavelength.

In some embodiments, the cell counting device comprises a plurality of microfluidic channels, each configured to receive a flow of a cell-containing fluid through an inlet and conduct the flow of the cell-containing fluid along the microfluidic channel, each microfluidic channel sized such that target cells within the cell-containing fluid flow consecutively through the microfluidic channel; a plurality of first photodetectors, each arranged to receive light that has passed through the microfluidic channel at a first measurement point, such that signal from the photodetector varies due to the received light being restricted by the passage of cells across the first measurement point in the microfluidic channel; wherein the processor is configured to receive a signal from each of the plurality of first photodetectors, distinguish the size of cells passing through each of the microfluidic channels based on the received signal and count the number of target cell types flowing through the plurality of microfluidic channels.

In this way, multiple cells can be distinguished simultaneously thereby speeding up the rate at which the cell counting device can count the number of target cells. This is particularly useful when the device is required to produce rapid results.

Preferably, the cell counting device further comprises one or more light sources configured to illuminate the plurality of microfluidic channels, the one or more light sources arranged such the light from the one or more light sources passes through the plurality of microfluidic channels and is received by the plurality of first photodetectors.

Preferably, the cell counting device may comprise a layered structure, the layered structure comprising: a microfluidic chip comprising the plurality of microfluidic channels in an array; a photodetector layer comprising the plurality of photodetectors.

Preferably, the cell counting device of further comprises an optical filter layer arranged to block light from reaching the photodetector layer, wherein the optical filter comprises an array of openings arranged to allow light to pass through to the photodetector layer at positions corresponding to the measurement positions.

In this way, the cell counting device is easy to fabricate and manufacture. A commercially available photodetector array can be used as the photodetector layer and an optical filter layer with an array of openings means that only a group of pixels or one pixel at each photodetector in the array have one output channel. This reduces the photodetector being triggered at pixels other than those at the measurement points and prevents cells passing one measurement point from triggering a different measurement point. Advantageously, these features allow for the adaptation of commercially available resources into the cell counting device such that they can retrieve reliable measurements.

In some embodiments, the cell counting device further comprises a pressure relief channel, the pressure relief channel wider than any one of the microfluidic channels and arranged to permit a portion of the received cell-containing fluid to bypass the microfluidic channels, thereby regulating the flow pressure in the microfluidic channels.

In this way, the number of target cells flowing through the microfluidic channel is reduced which advantageously reduces the occurrence of blockages or the slowing down of the cells. Further, the cells avoid being undesirably pushed through the microfluidic channel when the pressure is too high at speeds which don't produce reliable measures.

In some embodiments, the one or more photodetectors comprise a single-photon avalanche diode (SPAD) or a Multi-Pixel-Photon Counter (MPPC).

These photodetectors are easily accessible such that the cell device can be manufactured cheaply and made available to the general public at a low cost.

According to a second aspect of the invention, there is provided a method for counting target cells within a cell-containing fluid, the method comprising: flowing a cell-containing fluid through a microfluidic channel sized such that target cells within the fluid flow consecutively through the microfluidic channel; illuminating the microfluidic channel with light from a first side of the microfluidic channel such that the light passes through the microfluidic channel and cell-containing fluid; receiving the light at the opposite side of the microfluidic channel with a photodetector such that signal from the photodetector varies due to the received light being restricted by the passage of cells across the microfluidic channel; distinguishing the size of a cell passing through the microfluidic channel based on the interruption time during which the signal received from the photodetector is reduced, thereby determining a target cell type.

In some embodiments, the method further comprises: directing excitation light at a measurement position within the microfluidic channel, the excitation light having a wavelength suitable to excite autofluorescence in a target cell; receiving autofluorescence emissions from a cell at the measurement point with an autofluorescence photodetector; distinguishing the type of the cell based on the interruption time and the signal from the autofluorescence detector, thereby determining a target cell type.

### BRIEF DESCRIPTION OF DRAWINGS

FIG. 1a schematically illustrates a cell counting device according to an embodiment.

FIG. 1b schematically illustrates the cell counting device in FIG. 1a in which the minimum width dimension of the microfluidic channel is less than the diameter of the target cell type.

FIG. 1c schematically illustrates the cell counting device in FIG. 1a wherein a path of light has been obstructed by the target cell.

FIG. 1d schematically illustrates a perspective view of the cell counting device in FIGS. 1a to 1c in the absence of a cell passing through the microfluidic channel.

FIG. 2a schematically illustrates a cell counting device according to an embodiment.

FIG. 2b schematically illustrates the cell counting device in FIG. 2a in which the minimum width dimension of the microfluidic channel is less than the diameter of the target cell type.

FIG. 3a schematically illustrates a cell counting device according to an embodiment.

FIG. 3b schematically illustrates the cell counting device in FIG. 3a in which the minimum width dimension of the microfluidic channel is less than the diameter of the target cell type.

FIG. 4 shows the relative fluorescence intensity emitted from four different cell types when illuminated at two different emission frequencies.

FIG. 5 schematically illustrates a cell counting device according to an embodiment suitable for easy manufacture.

FIG. 6 schematically illustrates a cell counting device according to an embodiment in which fluid relief channels are included.

FIG. 7 schematically illustrates a cell counting device according to an embodiment in which there are multiple microfluidic channels.

FIG. 8a schematically illustrates a cell counting device according to an embodiment in which there are multiple, staggered microfluidic channels.

FIG. 8b is an enlarged view of the cell counting device in FIG. 8a.

FIG. 9a schematically illustrates a cell counting device according to an embodiment in which there is an optical filter layer.

FIG. 9b is an enlarged view of the cell counting device in FIG. 9a.

FIG. 10 schematically illustrates a cell counting device according to an embodiment comprising a full chip structure.

FIG. 11 schematically illustrates a cell counting device according to an embodiment comprising full chip structure with a dark casing.

FIGS. 12a and 12b schematically illustrates a cell counting device according to an embodiment in which there are two optical filter layers.

FIGS. 13a and 13b schematically illustrates a cell counting device according to an embodiment in which there are three optical filter layers.

FIGS. 14a and 14b schematically illustrates a cell counting device according to an embodiment in which there are two optical filter layers and a focal lens.

FIGS. 15a and 15b schematically illustrates a cell counting device according to an embodiment in which there are three optical filter layers and a focal lens.

### DETAILED DESCRIPTION

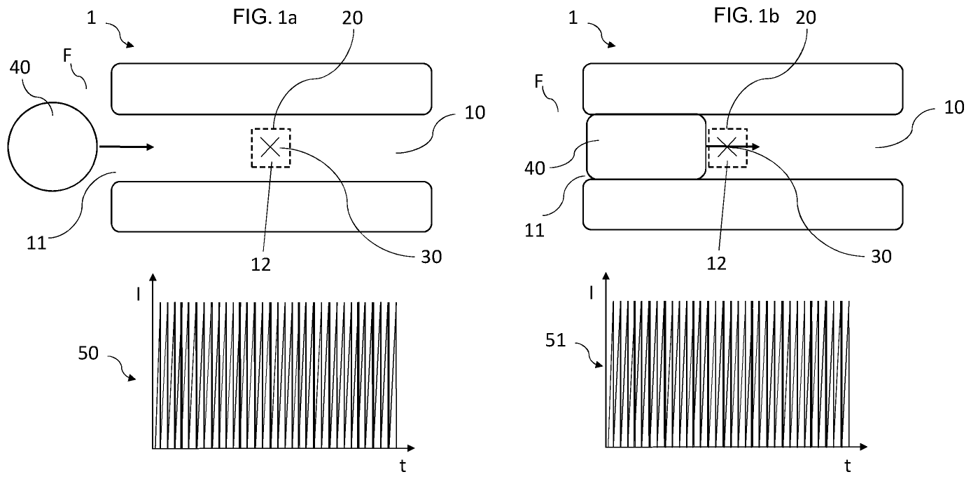

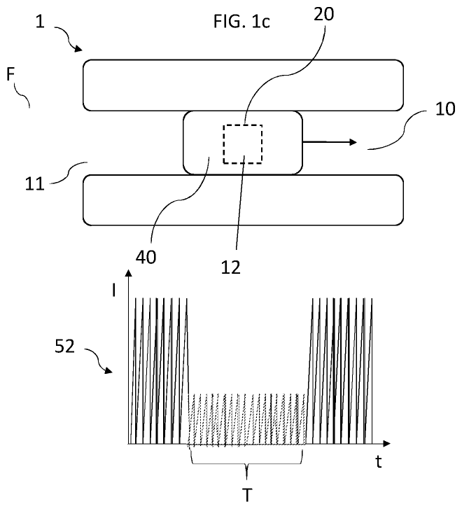

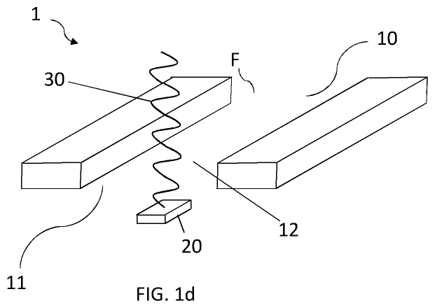

FIGS. 1a, 1b and 1c schematically illustrate a cell counting device 1 according to one embodiment of the present invention. The cell counting device 1 comprises a microfluidic channel 10 configured to receive a flow of a cell-containing fluid F through an inlet 11 and conduct the flow of the cell-containing fluid along the channel 10. The channel 10 is sized such that the target cells 40 within the fluid F flow consecutively through the microfluidic channel 10. In this embodiment, the minimum width dimension of the microfluidic channel 10 is less than the diameter of the target cell type within the fluid F when in a relaxed state. As demonstrated in FIGS. 1b and 1c, the target cell 40 is forced to deform from its relaxed shape as it flows through the microfluidic channel 10. In other examples, the minimum width dimension and/or depth of the microfluidic channel 10 may be greater than the diameter of the target cells 40, while still providing a sufficient channel width restriction such that target cells 40 within the cell-containing fluid F must flow consecutively through the microfluidic channel 10.

The target cell 40 is not limited to the circular shape shown in FIG. 1a. As apparent to the skilled person, the target cells 40 may be any particles or molecules within a solution or fluid F. Preferably, the target cell 40 is a biological particle, molecule or cell of the body found in a bodily fluid. The cell-containing fluid F may require no preparation before being used in the cell counting device 1. In a particularly embodiment the cell-containing fluid F is blood and the target cells 40 are blood cells, such as red blood cells, white blood cells and platelets. In some examples, the fluid F may be diluted with other substances including anticoagulants such that the concentration of target cells 40 in the sample is reduced, preventing potential overcrowding or blockage of the target cells 40 in the microfluidic channel 10. The flow of cells 40 through the microfluidic channel 10 may be passive, for example by diffusion or the capillary effect, or generated mechanically, for example, by injecting the fluid F into the device 1 via a syringe. The device 1 may be used with cells 40 that can actively move through the fluid F using their own energy without external forces and/or interference.

The cell counting device 1 shown in FIGS. 1a, 1b and 1c further includes a first photodetector 20 arranged to receive light 30 that has passed through the microfluidic channel 10 at a first measurement point 12. FIG. 1d shows a perspective view of the microfluidic channel 10 in the absence of a cell passing through the microfluidic channel 10 to demonstrate that the photodetector 20 is ideally located below the microfluidic channel 10 such that the light 30 can pass through the microfluidic channel 10 before reaching the photodetector 20. In FIG. 1a, the target cell 40 has not yet passed the inlet 11 of the microfluidic channel 10 such that the first photodetector 20 receives a constant stream of light 30 that has passed uninterrupted through the microfluidic channel 10. Whereas, in FIG. 1c the path of light 30 has been obstructed by the target cell 40 such that there is no received light 30 by the photodetector 20 since the target cell 40 is passing over the photodetector 20. Although the target cell 40 in FIG. 1c prevents all light 30 from reaching the photodetector 20, in the case of a partially translucent target cell 40 passing over the photodetector 20, there will be a reduction in the signal intensity received by the photodetector 20.

The photodetector 20 may be one of a photomultiplier, a pyroelectric detector, a semiconductor-based photoconductor, a phototransistor, or a photodiode. Preferably the photodetector 20 is a single pixel within a single-photo avalanche diode (SPAD) or Multi-Pixel-Photon Counter (MPPC).

Graphs 50, 51 and 52 shown in FIGS. 1a, 1b and 1c respectively illustrate the received signal by the processing unit from the photodetector 20. As shown in graph 52, the interruption time T is determined by a reduction in signal intensity until it returns to its original intensity value. The processing unit is configured to distinguish the size of the cell 40 passing based on the measured interruption time T thereby determining the presence of the target cell type. In an instance when the minimum width dimension is less than the diameter of the target cell 40, the cell elongates as it passes through the microfluidic channel 10 creating a longer interruption time T and thereby a more readily identifiable signal at the photodetector 20.

Optionally, the processor unit may be configured to adjust the interruption time T measurements to account for cells that have passed through the microfluidic channel 10 previously such that the passing cell 40 can be determined to be the correct cell type. This is advantageous when a cell 40 may slow down or be stuck in the microfluidic channel 10 causing subsequent cells 40 to also slow or stop.

The processing unit may also be configured to use the relative reduction in signal intensity during the interruption time T as a signal to distinguish cell types. For example, certain cells have a similar size but different absorption properties such that both the interruption time T, providing a measure of the size of the cell 40, and the relative intensity of the signal during interruption time, providing a measure of the absorption of the illuminating light by the cell 40, can be used to determine a target cell types.

The relative intensity of the signal during interruption time T may vary for a given cell type. As the cell 40 passes across the measurement point 12 there may be a change in intensity of the received signal due to varying absorption properties across the cell 40 such that the cell type can be determined. For example, red blood cells have a central pallor which causes a change in absorption properties and therefore a change in signal intensity. The processing unit can be configured to use this distinctive change in signal intensity to determine the cell type to be a red blood cell type. The processing unit may additionally use the interruption time T of the cell 40 to further confirm the cell type.

The fluid F is not limited to containing only one cell type and may contain many different cell types. The embodiment shown in FIGS. 1a, 1b and 1c is advantageous for differentiating different cell types with a relatively large size difference. For example, blood contains seven different cell types. The embodiment shown in FIGS. 1a, 1b and 1c can be used to distinguish red blood cells—which have a diameter of approximately 6 to 8 μm—and different types of white blood cells—which have a diameter within the range of around 5 to 30 μm. In this example, in which the device is configured to provide a full blood cell count, the minimum channel width would preferably be chosen such that the red blood cells occupy most of the channel width such that they flow consecutively through the microfluidic channel 10. The minimum channel width is further chosen as to not deform the white blood cells too much that they get stuck in the microfluidic channel 10. As such, when in the microfluidic channel 10, the red blood cells will pass through in their relaxed state or with minimal deformation. The white blood cells will be forced to deform such that they become elongated and slow down. The chosen minimum channel width for this specific application of the device 1 may be 5 to 10 μm.

The slowing down of the white blood cell arises from frictional forces acting on the white blood cell as it moves through the microfluidic channel 10 and is in constant contact with the walls of the microfluidic channel 10. A notable difference in the interruption time T received by the processing unit caused by the red blood cell compared to that caused by white blood cell allows the processor unit to distinguish the size of the cell 40 thereby the cell type based on the interruption time T. The processing unit may determine the count of red and white blood cells in a given sample or calculate a ratio of red to white blood cells in a given sample.

In another example, the cell counting device 1 of FIG. 1 can be used to distinguish between different white cell types. White blood cells are classified into five types: Neutrophils, Eosinophils, Basophils, Lymphocytes and Monocytes. These cells vary in size (values found in the table below) and therefore will undergo different degrees of deformation—based on their mechanical and elastic properties. Since the interruption time T is dependent on the size of the cell 40, the received signal can therefore be used to distinguish different white cell types, particularly lymphocytes and monocytes which vary largely in size To further differentiate cell types with similar interruption times T, the processing unit may be further configured to determine the intensity of signal from each cell since different cell types may have different absorption spectrums. It should be noted that the device 1 is not limited to use with red and white blood cells, nor is it limited to only distinguishing these cell types.

TABLE 1

| | White blood cell | | | | |
|---|---|---|---|---|---|
| | | | | | Mono- |
| | Neutrophils | Eosinophils | Basophils | Lymphocytes | cytes |
| Size | 12-14 | 12-17 | ~12 | 6-9 | <30 |
| (μm) | | | | | |

In other examples, the cell counting device 1 can be used to identify syphilis cells in a urine sample or the cell counting device 1 can be used to identify circulating tumour cells to detect metastasising tumours in a similar manner to the example above.

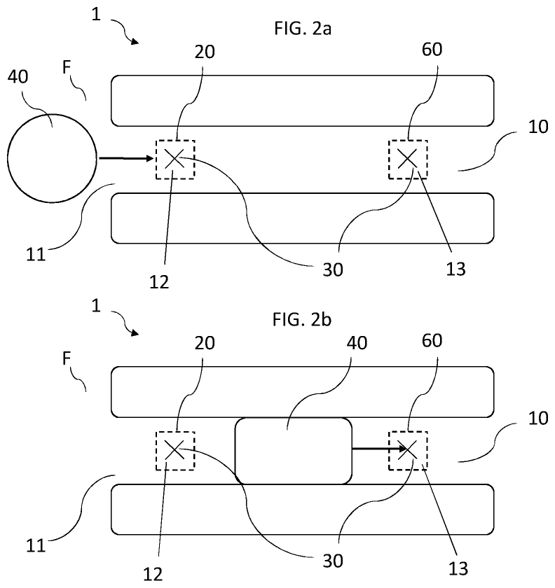

FIGS. 2a and 2b show an alternative arrangement of the cell counting device 1. The cell counting device 1 comprising of a first detector 20 arranged to receive light 30 that has passed through the microfluidic channel 10 at a first measurement point 12 and a second photodetector 60 arranged to receive light 30 that has passed through the microfluidic channel 10 at a second measurement point 13. The first measurement point 12 and second measurement point 13 are separated along the microfluidic channel 10 in the flow direction. In this arrangement, the processor unit will receive a signal from each photodetector 20 60 such that it may be configured to determining the interruption time T caused by a passing cell 40 at each photodetector 20 60 in the same manner as the photodetector 20 described in FIG. 1a. The processor unit can additionally or instead be configured to determine the speed at which the cell 40 transverses in a distance separating the first measurement point 12 and second measurement point 13. The distance separating the first measurement point 12 and second measurement point 13 is a known value thus, by determining the time taken for the cell to travel from the first measuring point 12 to the second measurement point 13, the processor unit can divide the distance value with the time value to determine the speed at which the cell 40 is travelling. Preferably, the distance between the two measurement points 12 13 is chosen to be large enough that small time differences between traversing cell types are more noticeable. The processing unit may calculate an average speed value for each cell 40 in a sample. Alternatively, the processing unit may calculate the average speed for each cell type in a sample.

Specifically, the arrangement in FIGS. 2a and 2b containing two photodetectors 20, 60 is advantageous for distinguishing different cell types of a similar size. Since larger cells deform by a greater degree than smaller cells, they will pass through the microfluidic channel 10 at a slower speed than the smaller cells such that it is possible for the processing unit to determine the cell type based on the speed at which the cell 40 transverses the distance between the first measurement point 12 and second measurement point 13. From Table 1, different white blood cell types are known to be similar in size. Using an embodiment of the device 1 shown in FIGS. 2a and 2b, white blood cells can be distinguished. The microfluidic channel length can be chosen such that the distance between the first measurement point 12 and second measuring point 13 is long enough for the processing unit to register small differences in the time taken for each white blood cell to transverse the microfluidic channel 10 thereby calculating the speed of the cell such that the white blood cell type can be distinguished. An example length of the microfluidic channel 10 used for white blood cells is 640 μm.

In an alternative example of the cell counting device 1, the cell-carrying fluid F may contain sperm cells. Animals produce motile sperm with tails known as flagellum which enables them to move—or swim—through a medium. The medium can be any fluid F that facilitates the sperm cells with the right conditions to stay alive and mobile. It is known to the skilled person that sperm cells carrying male genetic material (Y chromosome) move at a different speed to those carrying female genetic material (X chromosome). The processing unit may be configured to determine the speed of each sperm cell as it travels from the first measurement point 12 to the second measurement point 13 within the microfluidic channel 10 such that it can calculate a ratio of the sperm cells carrying male genetic material to the sperm cells carrying female genetic material, and/or give a count of each sperm type in the sample. In this example, the sperm cell 40 is not required to deform through the microfluidic channel 10 however in other examples it may deform through the microfluidic channel 10. Sperm cells carrying male genetic material and sperm cells carrying female genetic material are known to be different in size such that they can be differentiated using an embodiment of the cell counting device 1 that determines the cell type using the interruption time T. Preferably, in this example the sperm cells 40 will deform through the microfluidic channel 10 such that small differences in their respective interruption times T can be identified.

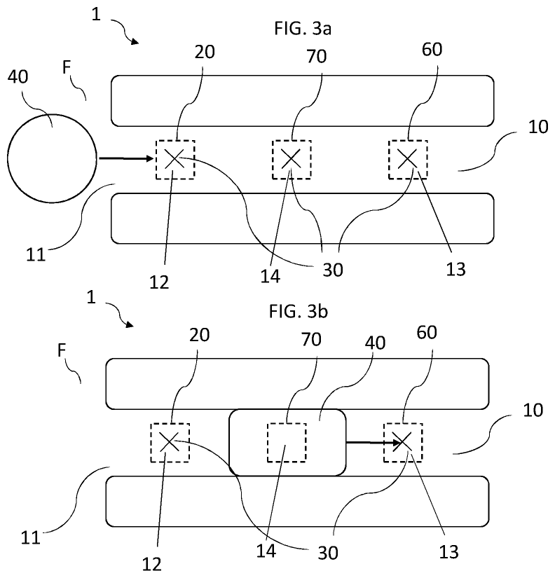

FIGS. 3a and 3b show the cell counting device 1 comprising three photodetectors 20, 60, 70. The third photodetector 70 is arranged to receive light 30 that has passed through the microfluidic channel 10 at a third measurement point 14 and is positioned between the first photodetector 20 and the second photodetector 60. In this arrangement, one of these photodetectors 20, 60, 70 may be included in an autofluorescence sensor.

Autofluorescence sensors rely on the natural emission of fluorescence from the target cell 40. Most biological cells contain fluorescing chromophores, such that when irradiated by light of a specific wavelength, the cells 40 will give rise to a fluorescence emission, known as autofluorescence or natural fluorescence. In this way, these biological cells do not require fluorescent dyes for emission to occur. An autofluorescence sensor can be used with any particle, molecule or cell that emits fluorescence and is not limited to biological cells.

In an embodiment of the cell counting device 1 that includes an autofluorescence sensor, the autofluorescence sensor comprises a light source and photodetector, which may be referred to as the autofluorescence photodetector, arranged such that the photodetector receives autofluorescence emissions from the cell 40 illuminated by the light source. Preferably, the light source is directly above the photodetector for maximal illumination of the cell 40. It is preferable that the light source of the autofluorescence sensor is configured to emit light within a first wavelength range that has been selected to excite an autofluorescence signal when incident on the target cell type. Alternatively, the light source may be configured to emit a broadband range of frequencies in which one of an excitation frequency is included. The autofluorescence photodetector is preferably configured to have a maximum sensitivity in a second wavelength range that includes the peak frequency of autofluorescence emission signal from the target cell type. Preferably, first wavelength range does not overlap the second wavelength range such that the autofluorescence photodetector does not detect signals from the light source. In an embodiment of the cell counting device 1 including an autofluorescence photodetector, the processing unit is further configured to receive a signal from the autofluorescence photodetector and determine a cell type based on the intensity of the received signal.

When an autofluorescence sensor is used in the cell counting device 1, the autofluorescence photodetector may be one of any photodetector 20, 60 or 70. Preferably, the autofluorescence sensor includes the middle photodetector 70 such that that the distance between the first and second photodetectors 60, 70—used to calculate—the speed is maximised. The processing unit is configured to receive signals from the first photodetector 20, the second photodetector 60 and the autofluorescence photodetector 70 to determine the presence of a target cell type within the microfluidic channel 10 based on one or more of the interruption time T signals received from the first and/or second photodetector 20, 60; the speed at which a cell 40 traverses the microfluidic channel 10 between the first measurement point 12 and second measurement point 13 determined from the signals received from the first photodetector 20 and the second photodetector 60; and the intensity of the signal received from the autofluorescence photodetector 70. Other arrangements of the cell counting device 1 may include two autofluorescence sensors.

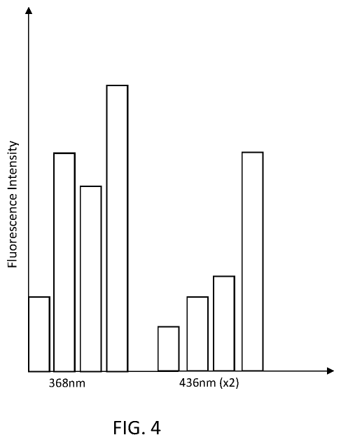

The intensity of the signal received by the processor unit from the autofluorescence photodetector 70 can be displayed graphically. FIG. 4 shows the autofluorescence intensity from four cell types at two different excitation frequencies. As is displayed by the graph, each cell type emits a different autofluorescence intensity at a given excitation wavelength such that they can be distinguished from one another based on this data.

As mentioned, FIG. 4 show the autofluorescence intensity from four cell types at two different excitation frequencies, providing different relative intensities between the cell types for the different excitation frequencies. This may be harnessed within the invention by two autofluorescence sensors using different excitation frequencies in the cell counting device 1, providing two signals for distinguishing the cell types. In this way, each autofluorescence photodetector can be configured to independently detect the two different autofluorescence frequency signals. In situations when two cell types have similar autofluorescence signal intensities at a particular excitation frequency, the signal intensity may be different for each cell type at a second autofluorescence frequency such that the two cell types can be differentiated based on the second intensity signal. The cell counting device 1 may include more than two autofluorescence sensors as to detect the intensity signals emitted from the target cells 40 at other excitation frequencies. In some examples, multiple autofluorescence sensors may be included in the cell counting device 1. In particular, the device may include a plurality of light sources, each configured to provide an excitation light at different wavelength to stimulate a different autofluorescence signal in the target cells. In this way, by detecting the different autofluorescence signals, the processor has additional information to distinguish different target cell types.

Embodiments of the cell counting device 1 including an autofluorescence sensor can be used to measure levels of haemoglobin and its derivatives in blood. Red blood cells are the most dominant absorbing element in the blood for the wavelength range 250-1100 nm. Light absorption by red blood cells is due to haemoglobin which has a different absorption spectrum depending on if it is bound to oxygen (oxyhaemoglobin) or unbound to oxygen (deoxyhaemoglobin).

Deoxygenated blood cells will absorb more light than oxygenated blood cells, thereby producing a weaker intensity signal at the photodetector. By configuring the autofluorescence photodetector to have a maximum sensitivity for a wavelength at which the red blood cells autofluoresce, the intensity signal can be used to determine the haemoglobin level in blood or the levels of its derivatives in the blood.

In any embodiment including at least one autofluorescence photodetector 20, 60, 70, it should be noted that the autofluorescence photodetector(s) 20, 60, 70 may additionally be configured to measure one or more of the interruption time T and the speed at which a cell 40 traverses the microfluidic channel 10 as well as the intensity of the signal received.

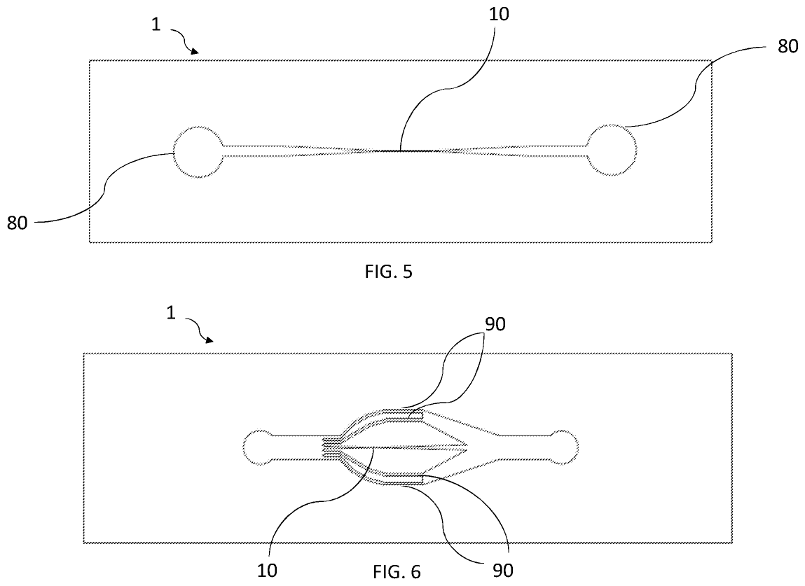

The design of the cell counting device 1 may be adapted for ease of manufacture. FIG. 5 shows the cell counting device 1 with a channel width that gets narrower, remains constant for a given length and widens again. The central portion of the channel whereby the walls have become parallel is the microfluidic channel 10 and can be configured in the same way as any of the embodiments of the cell counting device 1 shown in FIGS. 1-3. Designed in the way described, the cell counting device 1 becomes much easier to fabricate than a channel of very narrow dimensions over a relatively long length. The cell counting device 1 may further includes a reservoir 80 at either end of the channel for receiving fluid F. The shape of the reservoir 80 of the device 1 shown in FIG. 5 is particularly suited for receiving a droplet of fluid F, such as a droplet of blood or a droplet of fluid F dispensed from a pipette.

Ideally, any embodiment of the cell counting device 1 will include bespoke photodetector(s) 20, 60, 70. The bespoke photodetector(s) 20, 60, 70 can be customised such that they comprise the desired number of pixels for one output signal channel. Preferably, the bespoke design would comprise of one pixel having one output signal channel in which the one pixel perfectly aligns under the light source so the processing unit receives a signal from the output channel when the pixel receives light that has passed through the microfluidic channel 10. In contrast, a commercially available SPAD array detectors comprises an array of photodetector pixels in which each may be triggered to produce a signal when hit by a photon. The bespoke photodetector(s) 20, 60, 70 will produce a more accurate signal than commercially available photodetector(s) 20, 60, 70 as there are no neighbouring pixels to produce noise in the signal and there is no crosstalk between neighbouring pixels. Advantageously, bespoke photodetector(s) 20, 60, 70 can be designed to be relatively small in size such that no limitations are placed on the dimensions or design of the microfluidic channel 10 by the photodetector(s) 20, 60, 70.

However, it is not always viable to include bespoke photodetector(s) 20, 60, 70 in the cell counting device 1. As such, the cell counting device 1 can be adapted for commercial availability in which the photodetector(s) 20, 60, 70 may comprise of a Single-Photon-Avalanche Diode (SPAD) or a Multi-Pixel Photon Counter (MPPC), thereby reducing the cost of manufacture. SPADs are advantageous over other commercial options as they can determine the arrival of a single photon at a nanosecond level, thereby enhancing the accuracy of the measurements obtained by the photodetector(s) 20, 60, 70. When incorporating such photodetector(s) 20, 60, 70 into the device 1, there are a number of design considerations to ensure that the signal from each photodetector 20, 60, 70 can be received and processed individually, and does not spill into neighbouring detectors 20, 60, 70. Examples of these design considerations are explained below.

If the cell counting device 1 in FIG. 5 were to include at least two standard commercially available photodetectors 20, 60 which have predetermined dimensions, the length of the microfluidic channel 10 must be selected such that the two neighbouring photodetectors 20, 60 can be positioned next to one another along the channel length such that each receives signal from their associated measurement point 12, 13. Therefore, the channel length must be greater than the length of two adjacently positioned photodetectors 20, 60. Preferably, the channel length must not be too long that cells get stuck when deforming and passing through the microfluidic channel 10. In a specific example including two photodetectors 20, 60 of length 10 μm, the microfluidic channel 10 must be at least 20 μm in length.

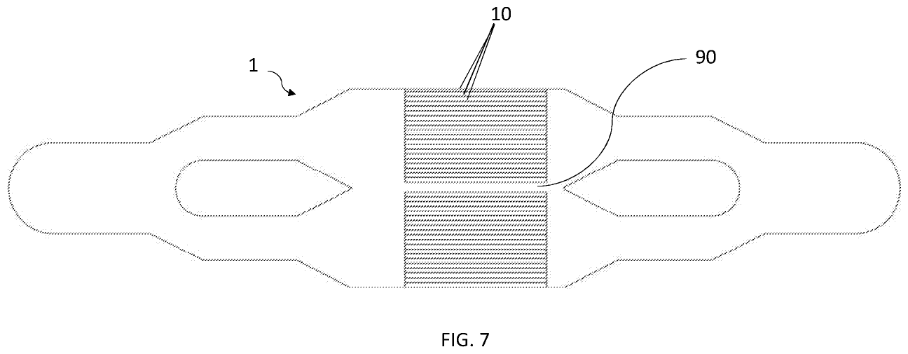

The cell counting device 1 may include at least one pressure relief channel 90. FIG. 6 shows the cell counting device 1 comprising multiple pressure relief channels 90. Preferably, the pressure relief channels 90 will be wider than the microfluidic channel 10 and arranged to permit a portion of the received cell-containing fluid F to bypass the microfluidic channel 10, thereby regulating the flow pressure in the microfluidic channel 10. In FIG. 6, the two pressure relief channels 90 on one side of the microfluidic channel 10 join to form one larger pressure relief channel 90. In other examples the pressure relief channels 90 may span different lengths of the device 10 and may not join to form one larger pressure relief channel 90. When pressure relief channels 90 are included in the cell counting device 1, the processing unit may be configured to account for the cells flowing in the pressure relief channels 90 when determining the number of each cell type in the sample. This could be done by the processing unit analysing the statistics of flow into the pressure relief channels 90 such that a ratio of the cells flowing in each pressure relief channel 90 and microfluidic channel 10 is calculated. The pressure relief channels 90 may not always follow a curved path and can have any viable design. FIG. 7 shows an exemplary cell counting device 1 comprising a plurality of microfluidic channels 10. The microfluidic channels 10 have the same channel length and are arranged parallel to one another. In other examples, the microfluidic channels 10 may not have the same length nor be parallel to one another. This device comprises only one central pressure relief channel 90, however, any number of pressure relief channels 90 may be included in the device 1.

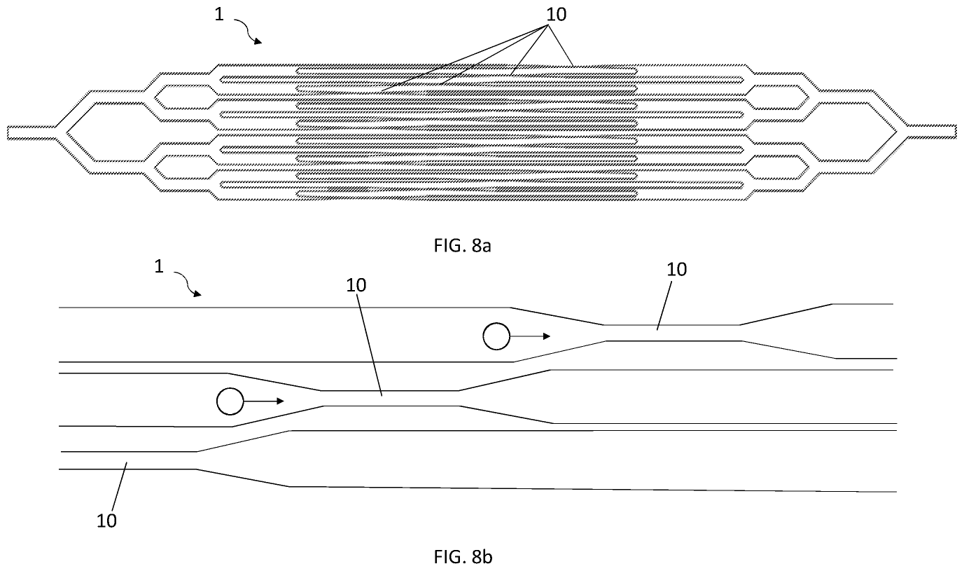

FIG. 8a shows an alternative exemplary cell counting device 1 in which is a plurality of microfluidic channels 10 are arranged for use with commercially available photodetector(s) 20, 60, 70. Shown is a staggered arrangement of microfluidic channels 10 at different lengthwise locations along the cell counting device 1. FIG. 8b magnifies a portion of the cell counting device 1 shown in FIG. 8a. The arrangement of channels 10 in this way may be preferable over the arrangement shown in FIG. 7 for use with a commercially available array of SPADs. Using a SPAD array, the microfluidic channels 10 have been positioned such that that measurement points 12, 13, 14 on adjacent channels 10 do not overlap the same detector so that each detector 12, 13, 14 can receive a single signal.

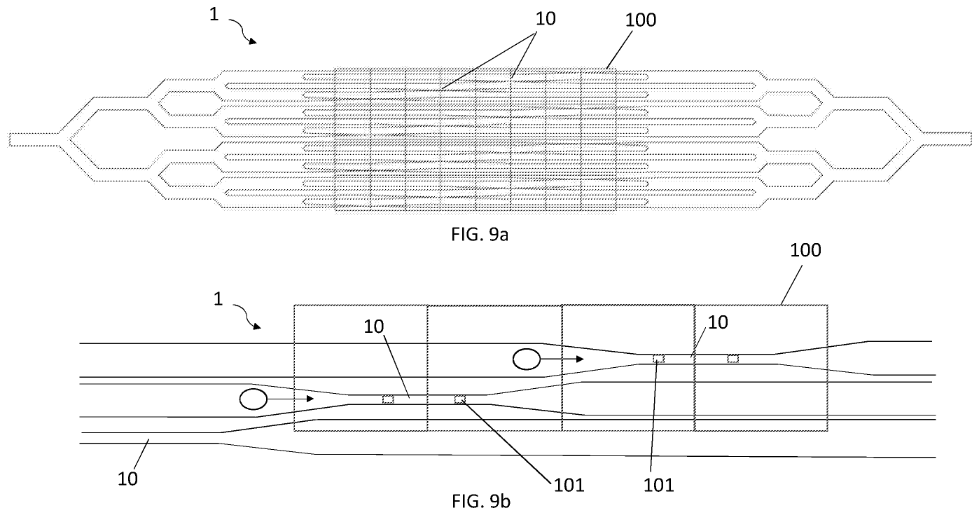

As described above, ideally, bespoke photodetector(s) 20, 60, 70 are used in the cell counting device 1, however, these are not always accessible and so addition features can be included to make commercially available ones more suitable. For example, SPADs comprises of many pixels spanning a relatively large area. Additionally, all the pixels in the SPAD, when hit by a photon, will trigger the same output channel signal. The problem with having many pixels for one output channel is the signal from individual pixels cannot be differentiated easily, and due to the relatively large size of the SPAD, some pixels will likely be constantly exposed to ambient light thereby producing a large amount of noise in the output signal. This makes it hard to acquire an accurate measure of the location of the target cell 40. As such, an overlaying optical filter layer 100 can be included in any embodiment of the device 1 that includes commercially available photodetectors(s) 20, 60, 70. FIGS. 9a and 9b show an exemplary cell counting device 1 with an optical filter layer 100.

The optical filter layer 100 may comprise an opening 101, wherein the optical filter layer 100 is configured to block light from reaching the multipixel photodetector array other than at a first pixel or group of pixels thereby producing an intensity signal only when the first pixel or group of pixels is illuminated. Preferably, the opening 101 has the same dimensions as a first pixel on the SPAD array and is aligned directly above the first pixel. An optical filter layer 100 spanning the cell counting device 1 may have more than one opening 101. Preferably there is only one opening 101 aligned with each SPAD such that the SPAD can only be illuminated by light at one pixel or pixel group in a given area. The openings 101 aligning to adjacent SPADs should be far enough apart in order to avoid crosstalk between pixels of different SPADs. The optical filter layer 100 may be positioned at a distance above the SPAD array such that light that has travelled through the opening 101 spreads out such that more than one pixel on each SPAD may be illuminated causing more than one pixel on the SPAD to produce an output signal.

The optical filter layer 100 may additionally filter out specific wavelengths or wavelength ranges thereby preventing them from reaching the photodetector(s) 20, 60, 70. For example, the optical filter layer 100 with or without openings 101 can be a fine grain emulsion film that blocks ultraviolet (UV) light—which is often the excitation frequency range—thereby blocking the excitation frequency from reaching the photodetector(s) 20, 60, 70.

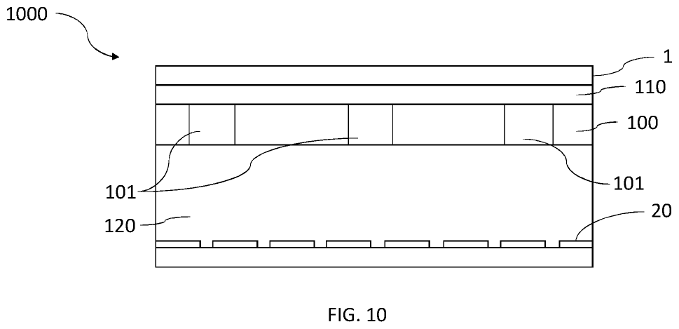

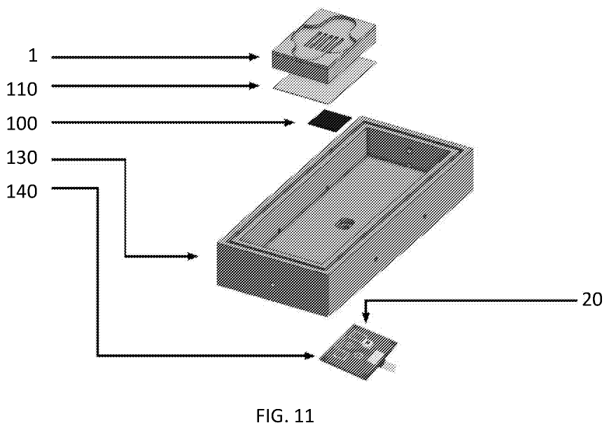

FIG. 10 shows the cell counting device 1 as a part of a full chip structure 1000. In one embodiment, the full chip structure 1000 may include the microfluidic channels 10 plasma bonded to a thin glass coverslip 110. The coverslip 110 may have a thickness of 100 μm. The glass coverslip 110 may be positioned between the optical filter layer 100 and the microfluidic channels 10. Preferably the optical filter layer 100 is a fine grain emulsion film of thickness 177 μm but other materials and/or other thicknesses can be used. An exemplary size for the openings 101 in the optical filter layer 100 is 10 μm, however, openings 101 of any size or shape may be used. A protection layer 120 of the photosensitive area may be included in the full chip structure 1000. The thickness of the protective layer 120 could range from 300 μm to 500 μm and may be composed of epoxy resin or silicon in commercially available photodetectors 20, 60, 70, however, in bespoke photodetectors 20, 60, 70 this layer may be much thinner. FIG. 10 shows several SPAD arrays positioned under the microfluidic channel 10. FIG. 11 shows an arrangement of the full chip structure 1000 in which the top microfluidic channel 10 layer is exposed to outside sources of light with the remaining components of the full chip structure 1000 enclosed in a dark casing 130 to avoid interference from light rays that have not passed through the microfluidic channel 10. FIG. 11 additionally shows a photodetector 20 connected to a circuit board which may be connected to a computer and oscilloscope for signal processing.

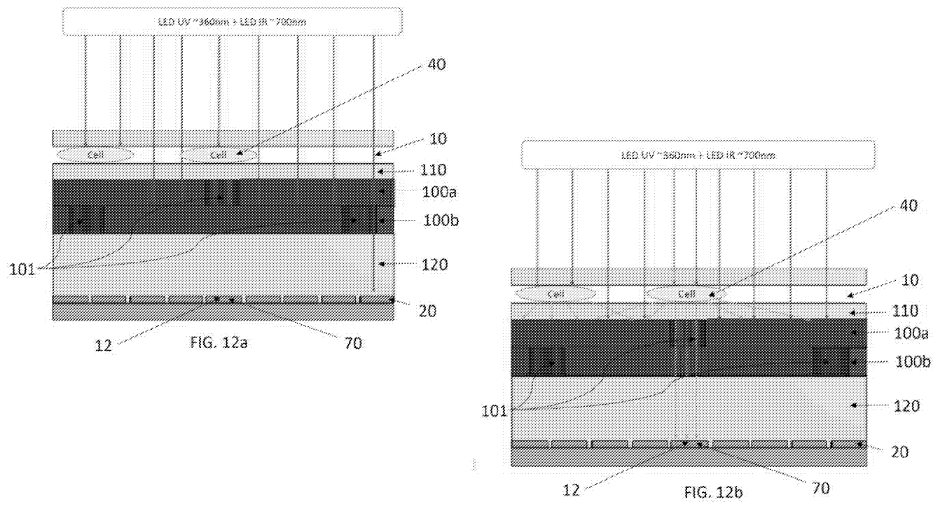

In other examples, the full chip structure 1000 may include more than one optical filter layer 100 as shown in FIGS. 12-15. Each optical filter layer 100 may block out different wavelength ranges from one another such that the noise in the signal received by the processing unit is reduced.

FIGS. 12a and 12b show an exemplary cell counting device 1 with two optical filter layers 100a 100b. As shown in FIG. 12, the cell counting device 1 may comprise of an excitation and autofluorescence filter layer 100a positioned between the microfluidic channel 10 and the photodetector(s) 20, 60, 70. The excitation and autofluorescence filter 100a is configured to block excitation and autofluorescence light respectively, but transmit illumination light. The excitation and autofluorescence filter 100a may be configured to block out a wavelength range of 200-600 nm for a given cell type. The excitation and autofluorescence filter 100a may comprise an opening 101 aligned so as to permit autofluorescence light from a cell at the third measurement point 14 to reach the autofluorescence detector 70.

The device 1 may further comprise of excitation and illumination light filter 100b positioned between the excitation and autofluorescence light filter 100a and the photodetectors 20, 60, 70. The excitation and illumination light filter 100b is configured to block excitation and illumination light but transmit autofluorescence light. The wavelength range of less than 420 nm and greater than 600 nm may be chosen for this filter for a given cell type. The excitation and illumination light filter 100b may comprise of two openings 101 positioned so as to permit illumination light passing through the first and second measurement positions 12, 13 to reach the first and second photodetectors 20, 60, as shown in FIG. 12a.

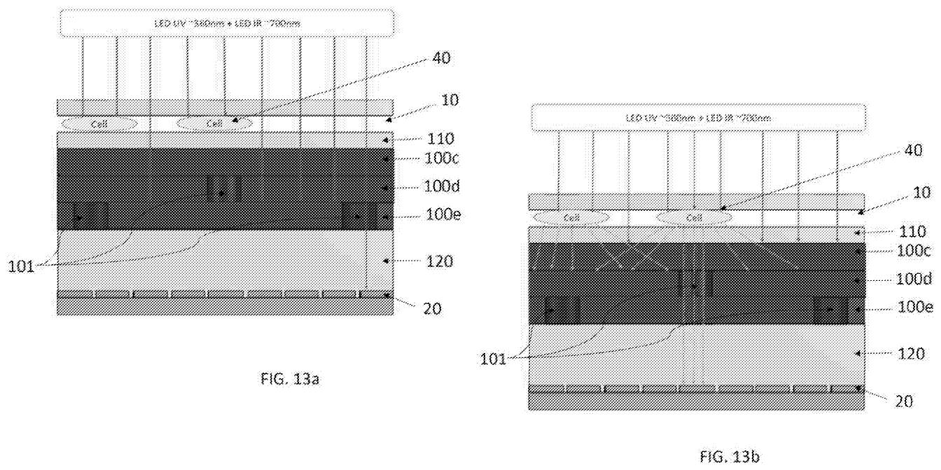

FIG. 13 shows another exemplary cell counting device 1 with three optical filter layers 100c, 100d, 100e. The cell counting device 1 may comprise an excitation light filter 100c positioned between the microfluidic channel 10 and the photodetectors 20, 60, 70. The excitation light filter 100c is configured to block excitation light but transmit illumination light and autofluorescence light. The device further comprises an autofluorescence light filter 100d positioned between the excitation light filter 100c and the photodetectors 20, 60, 70. The autofluorescence light filter 100d is configured to block autofluorescence light but transmit illumination light. The autofluorescence light filter 100d may comprise an opening 101 aligned so as to permit autofluorescence light from a cell 40 at the third measurement point 14 to reach the autofluorescence detector 70. The device further comprises an illumination light filter 100e positioned between the autofluorescence filter 100d and the photodetectors 20, 60, 70. The illumination light filter is configured to block illumination light and transmit autofluorescence light. The illumination light filter 100e may comprise two openings 101 arranged to permit illumination light passing through the first and second measurement points 12, 13 to reach the first and second photodetectors 20, 60 respectively.

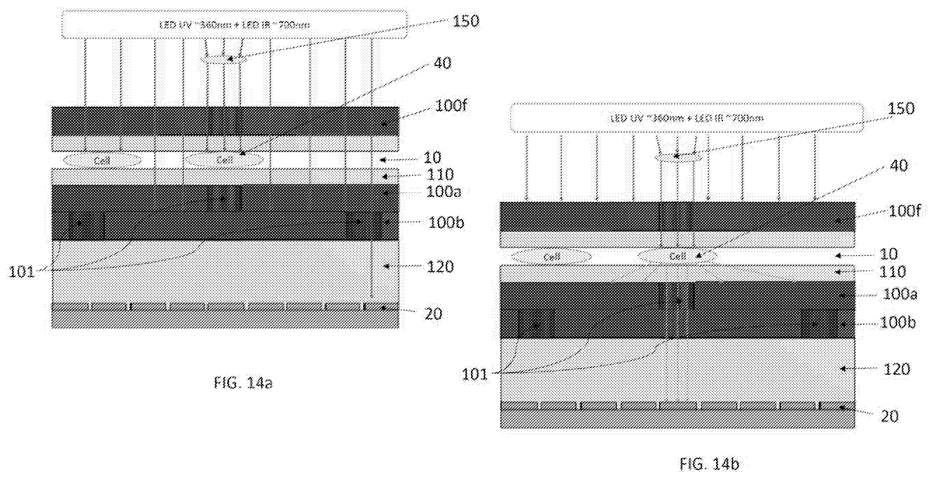

In some embodiments, the cell counting device 1 may include a focal lens 150 positioned between the excitation light source and the microfluidic channel 10. The focal lens 150 is configured to focus the excitation light towards the third measurement point 14 in a direction perpendicular to the microfluidic channel 10. In other embodiments, the focal lens 150 may be used to focus the excitation light towards other measurement points 12, 13, 14 on the microfluidic channel 10. In addition, the device 1 may include a focal lens filter 100f positioned between the focal lens 150 and the microfluidic channel 10, as shown in FIGS. 14a and 14b.

FIGS. 14a and 14b show an exemplary embodiment of the cell counting device 1 including a focal lens 150 and focal lens filter 100f in which there is also excitation and autofluorescence filter layer 100a and an excitation and illumination light filter 100b configured in the same way as FIGS. 12a and 12b.

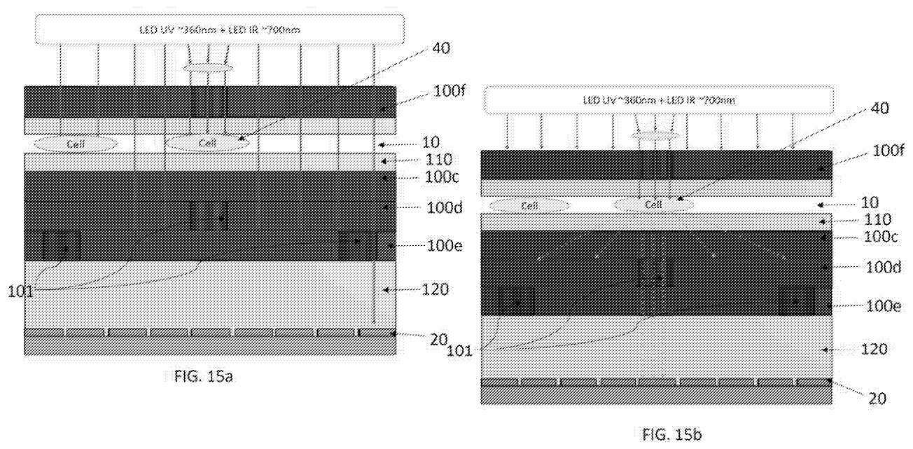

FIGS. 15a and 15b show an alternative exemplary embodiment of the cell counting device 1 including a focal lens 150 and focal lens filter 100f in which there is also an excitation light filter 100c, an autofluorescence light filter 100d and an illumination light filter 100e configured in the same way as FIGS. 13a and 13b.

It should be noted that any number of filters layers 100 may be used in the device 1 dependant on the target cell type. Any combination of optical filter layers 100 mentioned may be used in the cell counting device 1 in any order. Any of the filters 100 in the device 1 may contain openings 101 positioned above any of the photodetectors 20, 60, 70 such that the desired measurements may be retrieved.

Any embodiment of the device 1 may also include a focal lens 150 and optionally, a focal lens filter 100f.

In practice, the cell counting device 1 may be used in a laboratory or hospital as a desktop instrument. Alternatively, the device 1 is suitable for point-of-care and at-home use as a desktop instrument. The desktop instrument may be similar to that shown in FIGS. 11-15. The device 1 is further suited as an implantation device. In an implantation device the light source(s) may be included in the cell counting device 1. Alternatively, the implantable cell counting device 1 may be positioned such that it can receive light from an external source outside of the body. In this way, the device 1 may include a needle able to draw fluid F from inside the body towards the device 1 which may be attached on to the surface of the skin. The fluid F may not be required to be diluted when the device 1 is used as an implantation device. Example uses of the cell counting device 1 as an implantation device includes measuring the white blood cell count in spinal fluid and giving a real time blood count for patients participating in clinical trials.

1. A cell counting device for counting target cells within a fluid, the device comprising:
a microfluidic channel configured to receive a flow of a cell-containing fluid through an inlet and conduct the flow of the cell-containing fluid along the channel, the microfluidic channel sized such that target cells within the cell-containing fluid flow consecutively through the microfluidic channel;
a first photodetector arranged to receive light that has passed through the microfluidic channel at a first measurement point, such that signal from the photodetector varies due to the received light being restricted by the passage of cells across the first measurement point in the microfluidic channel;
a processing unit configured to receive a signal from the photodetector and distinguish the size of a cell passing the first measurement point based on an interruption time during which the signal intensity received from the photodetector is reduced, thereby determining the presence of a target cell type.

2. The cell counting device according to claim 1 wherein the processing unit is configured to determine the presence of a target cell type based on both:
the interruption time due to the passage of a cell across the first measurement point and the intensity variation of the signal during the interruption time.

3. The cell counting device of claim 1 or claim 2 wherein the minimum width dimension of the microfluidic channel is less than the diameter of a target cell type within the fluid when in a relaxed state, such that the target cell type is deformed from its relaxed shape as it flows through the microfluidic channel.

4. The cell counting device of any preceding claim further comprising:
a second photodetector arranged to receive light that has passed through the microfluidic channel at a second measurement point, such that signal from the photodetector varies due to the received light being restricted by the passage of cells across the second measurement point in the microfluidic channel;
wherein the first measurement point and second measurement point are separated along the microfluidic channel in the flow direction; wherein the processing unit is configured to:
receive signals from the first and second photodetectors and determine a speed at which a cell traverses a distance separating the first and second measurement points within the microfluidic channel; and
determine the presence of a target cell type using the determined speed.

5. The cell counting device of claim 4 wherein the minimum width dimension of the microfluidic channel is less than the diameter of a target cell type within the fluid when in a relaxed state, such that the target cell type is deformed from its relaxed shape as it flows through the microfluidic channel; wherein the processing unit is configured to:
determine the size of the cell using the determined speed at which the cell is travelling and the interruption time of the signal received from the first and/or second photodetector.

6. The cell counting device of any preceding claim comprising:
an autofluorescence sensor comprising an excitation light source and an autofluorescence photodetector arranged to receive autofluorescence emissions from a cell illuminated by the excitation light source; wherein the processing unit is configured to receive signal from the autofluorescence photodetector and determine a the presence of a target cell type based on the intensity of the received signal.

7. The cell counting device of any of claim 6 wherein the excitation light source is configured to provide light of wavelength in the range 250-700 nm.

8. The cell counting device of claim 6 or 7 comprising:
a first excitation light source configured to emit light of wavelength in the range 300-400 nm, preferably 360-370 nm; and
a second excitation light source configured to emit light of wavelength in range 400-500 nm, preferably 430-440 nm.

9. The cell counting device of any of claims 6 to 8, wherein the autofluorescence photodetector is positioned on an opposite side of the microfluidic channel to the excitation light source, the cell counting device further comprising:
an excitation light filter arranged between the microfluidic channel and the autofluorescence photodetector, the excitation light filter configured to block light in the wavelength range emitted by the excitation light source.

10. The cell counting device of any of claims 6 to 9, wherein the autofluorescence photodetector comprises the first photodetector, wherein the processing unit is configured to receive signal from the first photodetector, wherein the signal comprises both:
a varying intensity signal due to the received light being restricted by the passage of cells across the first measurement point in the microfluidic channel; and
an autofluorescence signal due to the autofluorescence emissions received from a cell passing the first measurement point in the microfluidic channel.

11. The cell counting device of any preceding claim wherein the microfluidic channel has a minimum width dimension of 1 μm-20 μm, preferably 5-15 um, more preferably 8-12 μm.

12. The cell counting device of any preceding claim wherein the target cells comprise blood cells and the microfluidic channel is sized such that the blood cells must pass consecutively through the microfluidic channel.

13. The cell counting device of any preceding claim comprising:
a second photodetector arranged to receive light that has passed through the microfluidic channel at a second measurement point, such that signal from the photodetector varies due to the received light being restricted by the passage of cells across the second measurement point in the microfluidic channel, wherein the first measurement point and second measurement point are separated along the microfluidic channel in the flow direction; and
an autofluorescence sensor comprising an excitation light source configured to illuminate a cell as it passes an autofluorescence measurement point and an autofluorescence photodetector arranged to receive autofluorescence emissions from the illuminated cell;
wherein the processing unit is configured to receive signals from the first photodetector, the second photodetector and the autofluorescence sensor and determine the presence of a target cell type within the microfluidic channel based on one or more of:
the interruption time of the signal received from the first and/or second photodetector;
the speed at which a cell traverses the microfluidic channel between the first and second measurement points determined from the signals received from the first and second photodetector; and
the intensity of the signal received by the autofluorescence sensor.

14. The cell counting device of claim 13 wherein the excitation light source is configured to provide excitation light comprising light in a first wavelength range for stimulating autofluorescence emission in a target cell type, the cell counting device further comprising:
an illumination light source configured to provide illumination light comprising light in a second wavelength range, wherein the illumination light source is configured to illuminate the microfluidic channel at the first and second measurement points to provide the signal to the first and second photodetectors;
wherein the first photodetector, second photodetector and the autofluorescence photodetector are arranged on an opposite side of the microfluidic channel to the excitation light source and the illumination light source.

15. The cell counting device of claim 14 wherein the excitation light source is an ultraviolet light source and the illumination light source is an infrared light source.

16. The cell counting device of claim 14 or 15 further comprising:
an excitation and autofluorescence filter positioned between the microfluidic channel and the photodetectors, the excitation and autofluorescence filter configured to block excitation and autofluorescence light but transmit illumination light, the excitation and autofluorescence filter comprising an opening aligned so as to permit autofluorescence light from a cell at the autofluorescence measurement point to reach the autofluorescence detector;
an excitation and illumination light filter positioned between the excitation and autofluorescence light filter and the photodetectors, the excitation and illumination light filter configured to block excitation and illumination light but transmit autofluorescence light, the excitation and illumination light filter comprising two openings positioned so as to permit illumination light passing through the first and second measurement positions to reach the first and second photodetectors.

17. The cell counting device of claim 14 or 15 further comprising:
an excitation light filter positioned between the microfluidic channel and the photodetectors, the excitation light filter configured to block excitation light but transmit illumination light and autofluorescence light;
an autofluorescence light filter positioned between the excitation light filter and the photodetectors, the autofluorescence light filter configured to block autofluorescence light but transmit illumination light, the autofluorescence light filter comprising an opening aligned so as to permit autofluorescence light from a cell at the autofluorescence measurement point to reach the autofluorescence detector;
an illumination light filter positioned between the autofluorescence filter and the photodetectors, the illumination light filter configured to block illumination light and transmit autofluorescence light, the illumination light filter comprising two openings arranged to permit illumination light passing through the first and second measurement points to reach the first and second photodetectors.

18. The cell counting device of any of claims 13 to 17 further comprising:
a focal lens positioned between the excitation light source and the microfluidic channel, the focal lens configured to focus the excitation light towards the autofluorescence measurement point in a direction perpendicular to the microfluidic channel.

19. The cell counting device of any of claims 13 to 18 wherein the autofluorescence photodetector comprises the first photodetector; wherein the processing unit is configured to receive signal from the first photodetector, wherein the signal comprises both:
a varying intensity signal due to the received light being restricted by the passage of cells across the first measurement point in the microfluidic channel; and
an autofluorescence signal due to the autofluorescence emissions received from a cell passing the first measurement point in the microfluidic channel

20. The cell counting device of claims 19 wherein the previously defined autofluorescence sensor is referred to as a first autofluorescence sensor, the cell counting device further comprising:
a second autofluorescence sensor comprising a second excitation light source configured to illuminate a cell as it passes a second autofluorescence measurement point and a second autofluorescence photodetector arranged to receive autofluorescence emissions from the excited cell;
wherein the second autofluorescence photodetector comprises the second photodetector;
wherein the excitation light sources of the first and second autofluorescence sensors are configured to emit light of different wavelengths.

21. The cell counting device of any preceding claim comprising:
a plurality of microfluidic channels, each configured to receive a flow of a cell-containing fluid through an inlet and conduct the flow of the cell-containing fluid along the microfluidic channel, each microfluidic channel sized such that target cells within the cell-containing fluid flow consecutively through the microfluidic channel;
a plurality of first photodetectors, each arranged to receive light that has passed through the microfluidic channel at a first measurement point, such that signal from the photodetector varies due to the received light being restricted by the passage of cells across the first measurement point in the microfluidic channel; wherein
the processor is configured to receive a signal from each of the plurality of first photodetectors, distinguish the size of cells passing through each of the microfluidic channels based on the received signal and count the number of target cell types flowing through the plurality of microfluidic channels.

22. The cell counting device of claim 21 comprising a layered structure, the layered structure comprising:
a microfluidic chip comprising the plurality of microfluidic channels in an array;
a photodetector layer comprising the plurality of photodetectors;
an optical filter layer arranged to block light from reaching the photodetector layer, wherein the optical filter comprises an array of openings arranged to allow light to pass through to the photodetector layer at positions corresponding to the measurement positions.

23. The cell counting device of claim 21 or 22 further comprising a pressure relief channel, the pressure relief channel wider than any one of the microchannels and arranged to permit a portion of the received cell-containing fluid to bypass the microfluidic channels, thereby regulating the flow pressure in the microfluidic channels.

24. A method for counting target cells within a cell-containing fluid, the method comprising:
flowing a cell-containing fluid through a microfluidic channel sized such that target cells within the fluid flow consecutively through the microfluidic channel;
illuminating the microfluidic channel with light from a first side of the microfluidic channel such that the light passes through the microfluidic channel and cell-containing fluid;
receiving the light at the opposite side of the microfluidic channel with a photodetector such that signal from the photodetector varies due to the received light being restricted by the passage of cells across the microfluidic channel;
distinguishing the size of a cell passing through the microfluidic channel based on the interruption time during which the signal received from the photodetector is reduced, thereby determining a target cell type.

25. The method according to claim 24 further comprising:
directing excitation light at a measurement position within the microfluidic channel, the excitation light having a wavelength suitable to excite autofluorescence in a target cell;
receiving autofluorescence emissions from a cell at the measurement point with an autofluorescence photodetector
distinguishing the type of the cell based on the interruption time and the signal from the autofluorescence detector, thereby determining a target cell type.
